(19) United States
(12) Patent Application Publication
(10) Pub. No.: US 2002/0144279 A1
(43) Pub. Date: Oct. 3, 2002

(54) Method and apparatus for providing custom television channels to viewers

(76) Inventor: Guojun Zhou, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/822,603

(22) Filed: Mar. 30, 2001

(51) Int. Cl. H04N 7/173

(52) U.S. Cl. 725/95; 725/105; 725/86

(57) ABSTRACT

Apparatus and method for transmitting one or more custom television channels to each of a plurality of customers. To create a custom channel, a customer selects one or more television programs using a customer interface and submits the selected television programs via the customer interface to a broker. The broker receives the selected television programs from one or more content providers and transmits the custom channels to the customers. Alternatively, the broker may generate custom channel data for each of a plurality of customers and send the custom channel data to a provider, the provider then transmitting the custom channels to the customers. A custom channel may include live television programs as well as pre-recorded television programs.

### FIELD OF THE INVENTION

The present invention relates to the distribution and transmission of television programming for viewing on video display devices, such as televisions, video monitors, and the like, located in homes, businesses, or other locations. Specifically, the present invention relates to methods and apparatus for providing viewer-specific television programming to each of a plurality of customers linked to a broker.

### BACKGROUND OF THE INVENTION

Since their introduction in the early Twentieth Century, televisions have permeated the homes of consumers in the United States and other countries. A household with two or more televisions is now commonplace. Moving in step with the proliferation of televisions into the home has been the growth of the video broadcasting industry. From its early beginnings, in which a handful of television stations provided minimal television programming broadcast over the air, the video broadcasting industry has grown into a multi-million dollar industry providing a diverse array of programming over a variety of mediums, including cable and direct-to-home satellite transmissions.

With the advent of modem cable and direct-to-home satellite transmission systems, whether digital or analog, a television viewer may now have tens—and, in some instances, hundreds—of cable or satellite channels to choose from, many of which provide twenty-four-hour programming. Although viewer choice is desirable, many people may simply become overwhelmed by the amount of video content available to them. Further, the presentation of available content to the television viewer is often inefficient and not user-friendly, leading to the phenomena known as “channel surfing.” The lack of an efficient and user-friendly program guide often leads to a scenario in which, despite paying for all channels available to them, a television viewer may only watch a small portion of the channels subscribed to and paid for. Conflicting television programs is another problem often experienced by television viewers, forcing a viewer to choose one program to view live among many the viewer may wish to watch. The sometimes overwhelming quantity of available content, the lack of an efficient system for selection of desired programming from the total available content, as well as the problem of conflicting program times results in viewers paying for a significant quantity of unwatched television content.

A consumer may also pay for a cable or direct-to-home satellite subscription including many channels the consumer finds uninteresting, or even objectionable. A common practice in the television broadcasting industry is to offer consumers a variety service levels, starting with a basic service level including a set group of channels and one or more higher service levels, each including the basic service channel group plus a specified group of additional channels. A consumer may wish to receive a certain number of desired channels; however, because the consumer must select from one of the service levels offered, the consumer must choose the service level that provides or most nearly includes the desired channels. Thus, the consumer is unable to subscribe to and pay for only those channels desired and, further, many of the channels included in the chosen service level may be objectionable or uninteresting to the consumer.

Currently available technology does not fully address—and, at best, only partially solves—the above-identified problems. Video recording devices (i.e., a “VCR”) are well known in the art and are nearly as pervasive as televisions themselves. Such video recording devices enable a viewer to pre-record a desired television program and to replay that program at a later time, the pre-recorded television program being stored on a magnetic tape or, more recently, an optically accessible disk or a hard disk drive. Video recording devices offer consumers some utility; however, these devices are inadequate to solve the problems noted above. Although recording only one or a small number of television programs for viewing, the user must still pay for all of the channels subscribed to. Also, only one of two conflicting programs can be recorded by most video recording devices, and generally a video recording device does not permit a viewer to watch one show live while recording a different program concurrently showing on another channel.

Another well known technology permitting some viewer choice is, what is often referred to as, “pay-per-view.” Most pay-per-view systems permit the consumer to choose from a relatively small number of programming selections for home viewing, with the selected programs generally being presented only at pre-scheduled viewing times. However, the consumer usually pays a specified fee for each program viewed, such pay-per-view fees being in addition to any fees already incurred by the consumer for a cable or direct-to-home satellite subscription. Furthermore, though offering the consumer some choice in viewing time, the program content available on pay-per-view is limited, generally including only a selection of new or recently released movies as well as certain live sporting events.

More recently, “video-on-demand” technology has enabled viewers to record for playback a relatively larger number of selected television programs. Video-on-demand systems typically include an on-screen electronic program guide providing users a listing of all available television programming from which the user may select one or more television programs for recording, the selected television programs being recorded and stored in digital format on a hard disk drive or other suitable storage medium. Multiple television programs can be stored on the storage medium and recalled therefrom by the user for viewing at any desired time and in any order. Some video-on-demand systems offer the viewer “VCR-like” functions, such as instant replay and slow motion viewing. These video-on-demand systems, however, still require the viewer to purchase a cable or satellite television subscription and, further, necessitate purchasing some type of digital video recording device.

Accordingly, there is a need in the art for methods and apparatus providing greater consumer choice and flexibility in selecting and receiving television programming. Such methods and apparatus must enable the viewer to efficiently select only desired content for viewing from a large pool of available television programming, while substantially eliminating fees paid for unwatched, uninteresting, or objectionable programming. Also, these methods and apparatus must permit viewer access to each of two or more conflicting or overlapping television programs.

### BRIEF DESCRIPTION OF THE DRAWINGS

FIG. 1 shows a schematic diagram of a prior art cable television or direct-to-home satellite distribution system.

FIG. 2 shows a schematic diagram of a television program distribution system according to one embodiment of the present invention.

FIG. 3 shows a schematic diagram of a television program distribution system according to another embodiment of the invention.

FIG. 4 shows a schematic diagram of a television program distribution system according to a further embodiment of the invention.

FIG. 5 shows a schematic diagram of a television program distribution system according to yet another embodiment of the invention.

FIG. 6 is a schematic diagram of a method of providing television programming according one embodiment of the present invention.

FIG. 7 is a schematic diagram of a method of providing television programming according to another embodiment of the invention.

FIG. 8 is a schematic diagram of a method of creating a custom channel according to the invention.

FIG. 9 shows a schematic diagram of a television program distribution system according to yet a further embodiment of the invention.

FIG. 10 is a schematic diagram of a method of providing television programming according to a further embodiment of the invention.

### DETAILED DESCRIPTION OF THE INVENTION

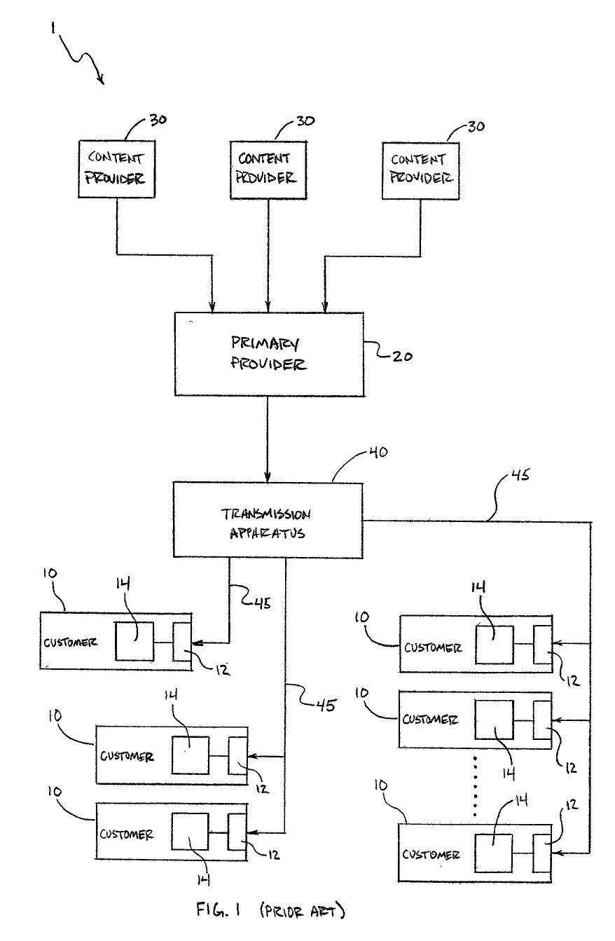

Conventionally, as shown in FIG. 1, a plurality of customers 10 receive television programming from a primary provider 20. The primary provider 20 may be a cable television provider, a direct-to-home satellite provider, a broadcaster (e.g., VHF, UHF), or other provider. The primary provider 20, in turn, receives programming content from one or more content providers 30, such as, for example, ESPN®, CNN®, HBO®, TNT®, or The Disney Channel®. As used herein, the term “content provider” refers to any provider of television programming, whether in digital or analog format, and irrespective of the particular type, format, or quality of programming. The primary provider 20 utilizes a transmission apparatus 40 to transmit television programming to each of the plurality of customers 10 over transmission media 45. The transmission apparatus 40 may comprise—whether digital or analog—a cable distribution system, a satellite transmission system, or a broadcasting system (i.e., for antenna reception). Transmission media 45 may comprise electrical cables (e.g., coaxial cable), fiber optics, or electromagnetic waves (i.e., for radio, line-of-sight microwave, and satellite transmissions).

A customer 10 will have a television 14 or other viewing device for receiving and viewing the television programming. A customer 10 may also have a decryption device 12—often referred to as a “cable box” —for decrypting any encrypted video signals received over transmission media 45. For example, it is common for pay-per-view programming and so called “premium” channels to be encrypted prior to transmission to subscribers. Generally, the television programming received by a customer 10 comprises a group of channels within a chosen service level offered by the primary provider 20. The customer 10 pays to the primary provider 20 a periodic subscription fee corresponding to the selected service level, irrespective of whether, or to what extent, the customer 10 views the various channels available to them. As noted above, the conventional television distribution system 1 provides inadequate consumer choice, ease of selection, and flexibility in the reception of television programming while also obligating consumers to incur subscription fees for unwatched programming. Also, although a viewer may receive broadcast television signals via antenna without incurring any fees, such broadcast television content is generally very limited and, further, antenna reception can be unreliable and exhibit poor quality.

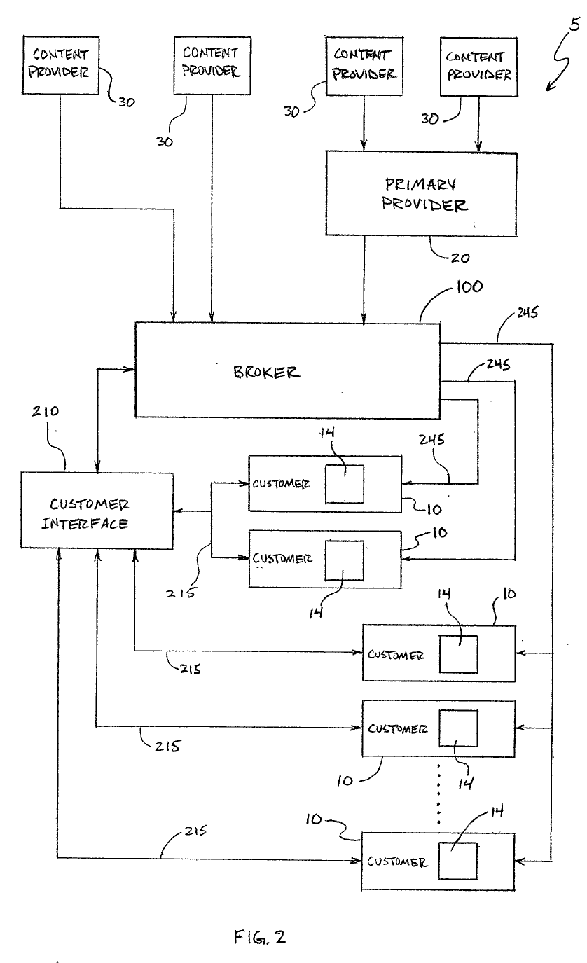

The present invention overcomes the above-identified deficiencies of prior art television programming distribution systems by enabling consumers to create and receive customized television channels. Shown in FIGS. 2 through 10 are embodiments of a television programming distribution system, as well as methods of providing television programming, that enable television viewers to create custom channels and to receive and pay for only the selected television programming.

Referring to FIG. 2, a television programming distribution system 5 according to one embodiment of the invention comprises a broker 100 linked via transmission media 245 with one or more customers 10, each customer 10 having a television 14 or other display device for receiving television programming. The broker 100 is also linked to a primary provider 20, such as a cable television or direct-to-home satellite provider, and receives television programming from the primary provider 20, the primary provider 20 receiving television programming from a plurality of content providers 30. Alternatively, in addition to receiving television programming from a primary provider 20—or in lieu of receiving television programming from primary provider 20—the broker 100 may be linked to one or more content providers 30 to receive television programming directly from the content providers 30.

The broker 100 may be any person, group, business entity, or other entity having the capability—e.g., a brokering apparatus—to transmit only selected programming from the primary provider 20 and/or content providers 30 to each of the plurality of customers 10. Customers 10 interact with the broker 100 through a customer interface 210, the customers 10 being linked to customer interface 210 by transmission media 215, and it is this customer interface 210 that enables customers 10 to create custom channels, as will be described in greater detail below. The transmission media 215 may comprise electrical cables, fiber optics, or electromagnetic waves, and, in an alternative embodiment, one or more customers 10 may be linked to the customer interface 210 via the same transmission media 245 over which the customer 10 receives television programming.

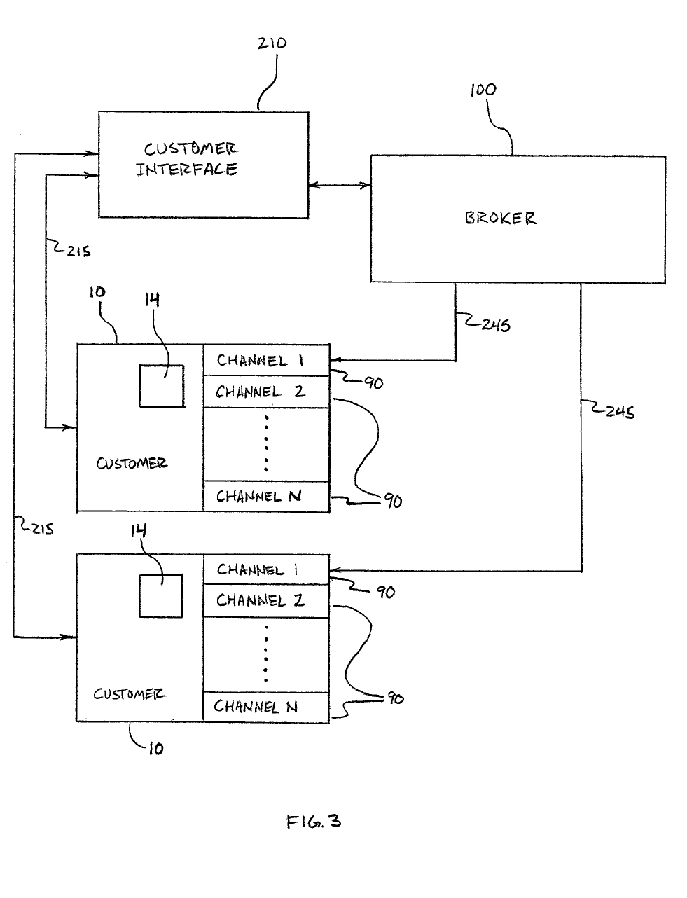

Referring to FIG. 3, each customer 10 creates using customer interface 210—and receives from broker 100 via transmission media 245—at least one custom channel 90 (i.e., CHANNEL 1). In another embodiment, a customer 10 may create and receive multiple custom channels 90 (i.e., CHANNEL 1 through CHANNEL N). Allowing a customer 10 to build two or more custom channels 90 may be useful in a number of situations. For example, a customer 10 may comprise a family of two or more viewers, and each of the viewers may wish to create their own custom channel 90 for viewing, in which case two or more of the custom channels 90 may be viewed simultaneously on separate televisions 14 within a household. Similarly, for a hotel, motel, apartment complex, or other multi-family residence having multiple rental units, it would be desirable to allow viewers in each rental unit to build and view a custom channel 90 independent of the television programming being viewed in other rental units. Also, providing a customer 10 with the ability to receive multiple custom channels 90 enables the customer 10 to receive two or more live television programs and to switch between these live television programs.

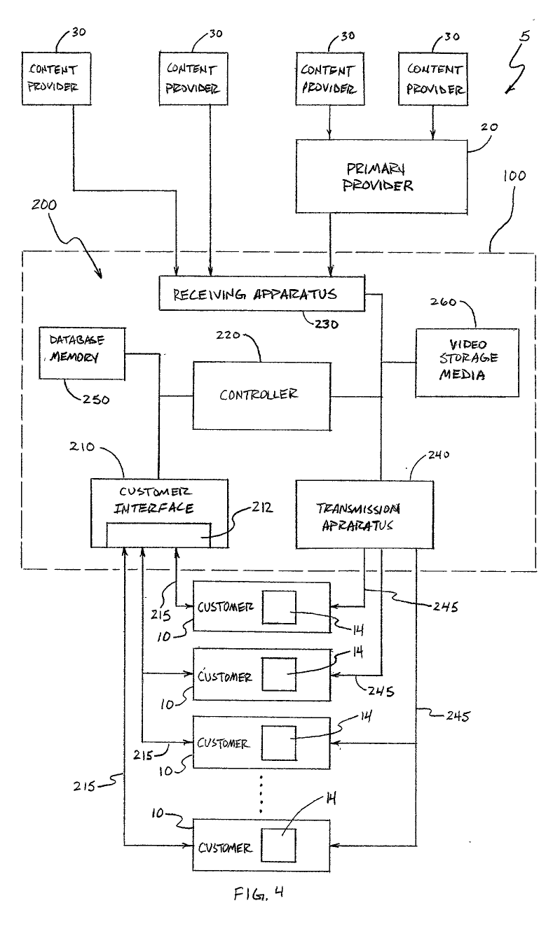

The broker 100 has a brokering apparatus 200, as shown in FIG. 4, for distribution of customized television programming to a plurality of customers 10. The brokering apparatus 200 includes a receiving apparatus 230 for receiving television programming from one or more primary providers 20 or directly from one or more content providers 30. The receiving apparatus is coupled to a transmission apparatus 240 configured to transmit desired television programming to customers 10 via transmission media 245. The transmission apparatus 240 may comprise any suitable method or device known in the art, including, in either digital or analog format, a cable television distribution system, a satellite transmission system, a broadcasting system, or other suitable content delivery system. Transmission media 245 may comprise electrical or fiber optic cables or electromagnetic waves.

In one embodiment of the brokering apparatus 200, video storage media 260 is coupled to the receiving apparatus 230 and transmission apparatus 240. Video storage media 260 may comprise any suitable video storage device known in the art, including, by way of example, magnetic tape, a hard disk drive, a server, or an optically accessible medium. Video storage media 260 may be used to record live television programming or other regularly scheduled programming for inclusion in a custom channel 90 and delayed transmission to a customer 10.

Customer interface 210 also forms a portion of brokering apparatus 200. The customer interface 210 provides customers 10 access to brokering apparatus 200, enabling customers 10 to build custom channels 90. The customer interface 210 is configured to provide a program guide to each customer 10 over transmission media 215, and is further configured to accept programming selections from customers 10 for the creation of custom channels 90. The program guide may be any suitable on-screen listing of available television programming that allows customers 10 to easily scan the available programming and make selections. For example, the program guide may comprise an electronic program guide (EPG) providing the viewer with an on-screen grid showing available programs and show times. Viewers may select a desired program by entering a program identification number corresponding to the desired program, by moving a cursor onto a square or block corresponding to the desired program and entering the selection, by highlighting a square or block corresponding to the desired program and entering the selection, or by any other suitable methods known in the art. The program guide may be further configured to provide customers 10 with an on-screen listing of selected programs comprising a custom channel, so that customers may confirm their selections prior to submitting the selections to the customer interface and/or receiving the custom channel 90.

In another embodiment, the program guide may comprise a web-based EPG provided via an internet connection. The internet connection may be established over transmission media 215 or any other suitable medium, such as a phone line. A customer 10 may then log onto the web-based EPG and enter their selections for one or more custom channels. The web-based EPG may be configured to display all programs comprising a custom channel, such that customers 10 can view the content of each custom channel 90 that was created prior to submitting the custom channel to customer interface 210 and/or receiving the custom channels 90.

In a further embodiment, the program guide may comprise a natural language program guide, enabling customers 10 to enter their selections by voice command. Voice entries may be submitted to customer interface 210 over a phone connection, over any wireless connection, or they may be submitted directly to a television that is configured to accept voice commands.

Customer interface 210 may also include access circuitry 212 for accepting user access codes. In order to insure that only authorized customers are submitting programming selections to the customer interface 210, each customer 10 may be assigned a user access code identifying that customer as one who has subscribed to the services offered by broker 100. Customers 10 would then submit their user access code to customer interface 210 prior to entering programming selection, and the user access code would then be verified by access circuitry 212. Access to user interface 210 could then be denied if a valid user access code was not provided.

In an alternative embodiment, access circuitry 212 could be used to restrict the access to programming of certain viewers. A user access code may be assigned specified access level that denies access to certain types of programming (e.g., programming having a PG-13 or R rating). Thus, a parent, by providing a child with a separate access code having a known access level, can restrict the programming (e.g., to those programs having a PG or G rating) that the child can add to a custom channel. Accordingly, by receiving only that television programming that has been assembled into a custom channel and, further, by restricting children from selecting certain types of programming for a custom channel, a parent can have a significant degree of control over the content of television programming being transmitted into their home for viewing by children.

The brokering apparatus 200 may also include database memory 250 coupled to customer interface 210, database memory 250 comprising any suitable memory device known in the art. Database memory 250 may be used to store customer data, including custom channel data (i.e., selected programming and viewing times), user access codes, access levels, as well as other subscriber and/or billing information used by broker 100.

A controller 220 is coupled to the various components of brokering apparatus 200 and is configured to control operation of the brokering apparatus 200. The controller 220 may comprise any suitable computer, CPU, processor, or other similar device. The controller 220 receives custom channel data from customer interface 210 and stores this data in database memory 250. Controller 220 also directs transmission apparatus 240 to transmit custom channels 90 to customers 10 at the selected viewing times. If a selected television program is to be viewed non-live (i.e., at any time later than the scheduled broadcast time for that program), the controller 220 will direct video storage media 260 to record and store the selected program for non-live viewing.

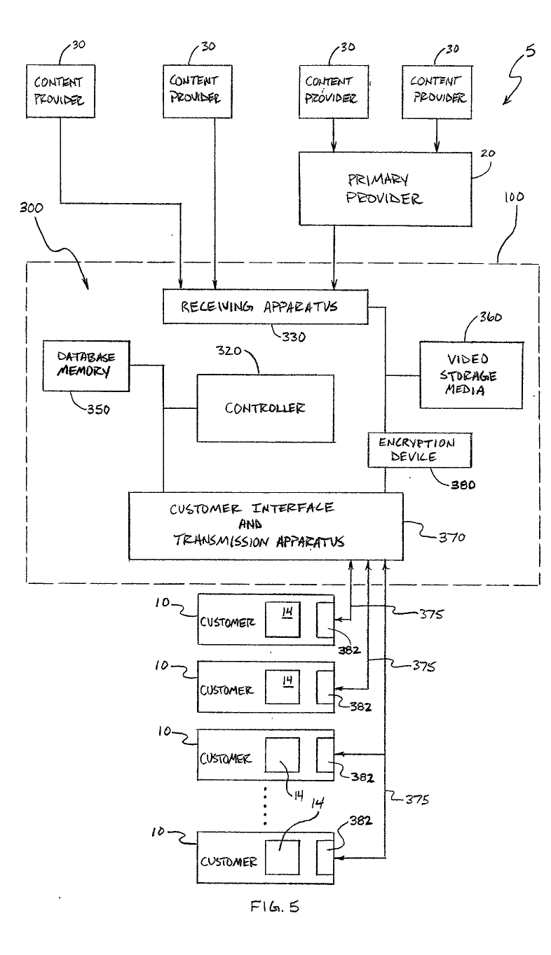

Although the components of brokering apparatus 200—i.e., customer interface 210, controller 220, receiving apparatus 230, transmission apparatus 240, database memory 250, and video storage media 260—illustrated in FIG. 4 are shown as separate components, those of ordinary skill in the art will appreciate that any one or more of the components of brokering system 200 may form an integrated system. For example, in another embodiment shown in FIG. 5, a brokering apparatus 300 includes an integrated customer interface-transmission apparatus 370. The brokering apparatus 300 shown in FIG. 5 is similar to the brokering apparatus 200 of FIG. 4; however, the customer interface and transmission apparatus form a single, integrated system 370 connected to one or more customers 10 via transmission media 375. Transmission media 375 may comprise electrical cables, fiber optics, or electromagnetic waves. For the embodiment illustrated in FIG. 5, transmission media 375 is used to transmit program guide data to customers 10, to transmit customer selections back to brokering system 300, and to transmit custom channels 90 to the customers 10.

In a further embodiment, also illustrated in FIG. 5, a brokering apparatus 300 may include an encryption device 380. Encryption device 380 encrypts the custom channel signals prior to transmission to customers 10. Each customer 10 has a decryption device 382 for decrypting the custom channel signal or signals. Encryption device 380 in conjunction with decryption devices 382 may be used to insure that only authorized customers receive custom channel signals transmitted from brokering apparatus 300 (or brokering apparatus 200).

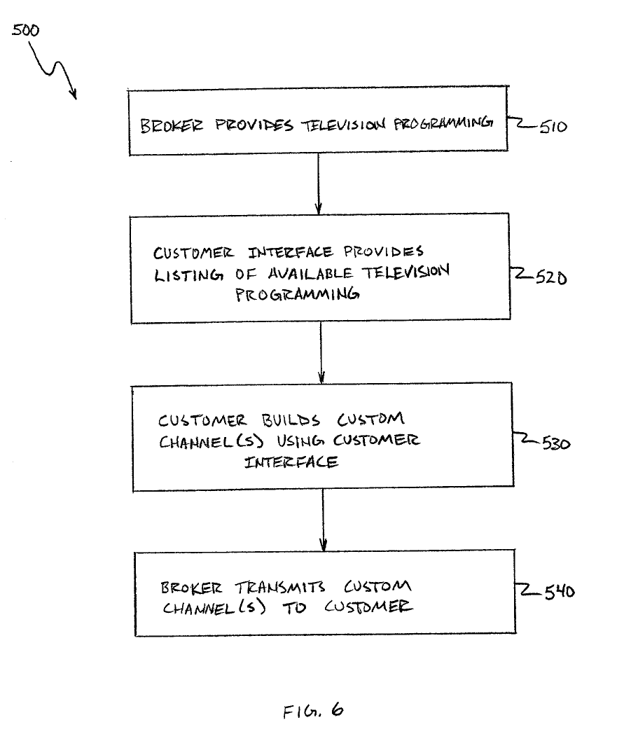

Referring now to FIG. 6, a method of providing custom channels 500 is shown. Denoted at 510, the broker 100 provides television programming, which is received from one or more primary providers 20 and/or one or more content providers 30. Referring to reference numeral 520, a listing of the available television programming is then provided to customers 10 by the customer interface 210, 370, the listing of available programming comprising a program guide such as an on-screen EPG, a web-based EPG, a natural language program guide, or any suitable combination of these program guides. A customer 10 may then build one or more custom channels 90 using the customer interface 210, 370, which is denoted at 530. The broker 100 transmits the custom channel or channels 90 to the customer 10, as identified by reference numeral 540, at the selected viewing times.

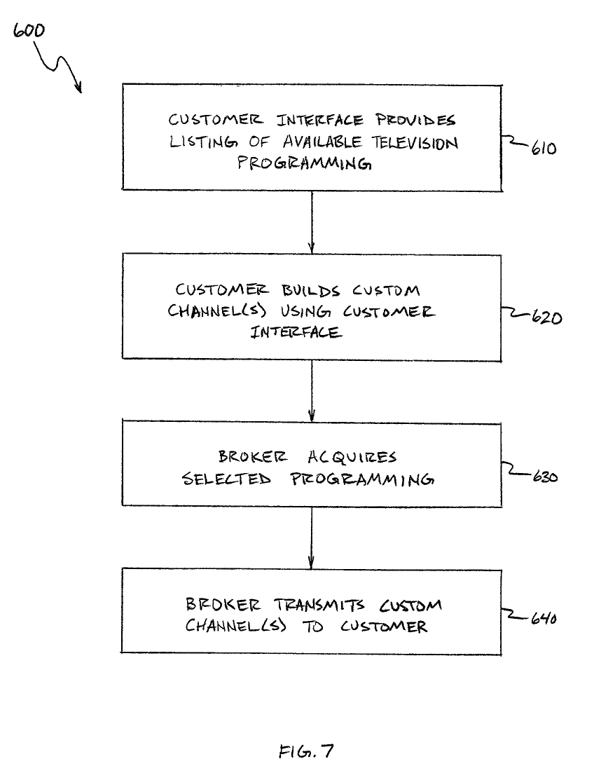

In an alternative embodiment, the broker 100 acquires from primary providers 20 and/or content providers 30 only that programming content that has been specifically selected by a customer 10, rather than receiving all of the content provided by one or more primary providers 20 and/or one or more content providers 30. Thus, with reference to FIG. 7, a method of providing custom channels 600 includes providing customers 10 a listing of available television programs, which is denoted at 610. Referring to reference numeral 620, customers 10 may then create custom channels using customer interface 210, 370. After receiving custom channel data, the broker 100 acquires only that television programming that has been selected by a customer 10 and added to a custom channel 90, which is denoted at 630. The broker 100, therefore, does not incur fees for programming content that has not been requested by a customer 10. Denoted at 640, the broker 100 then transmits the custom channel or channels to customers 10.

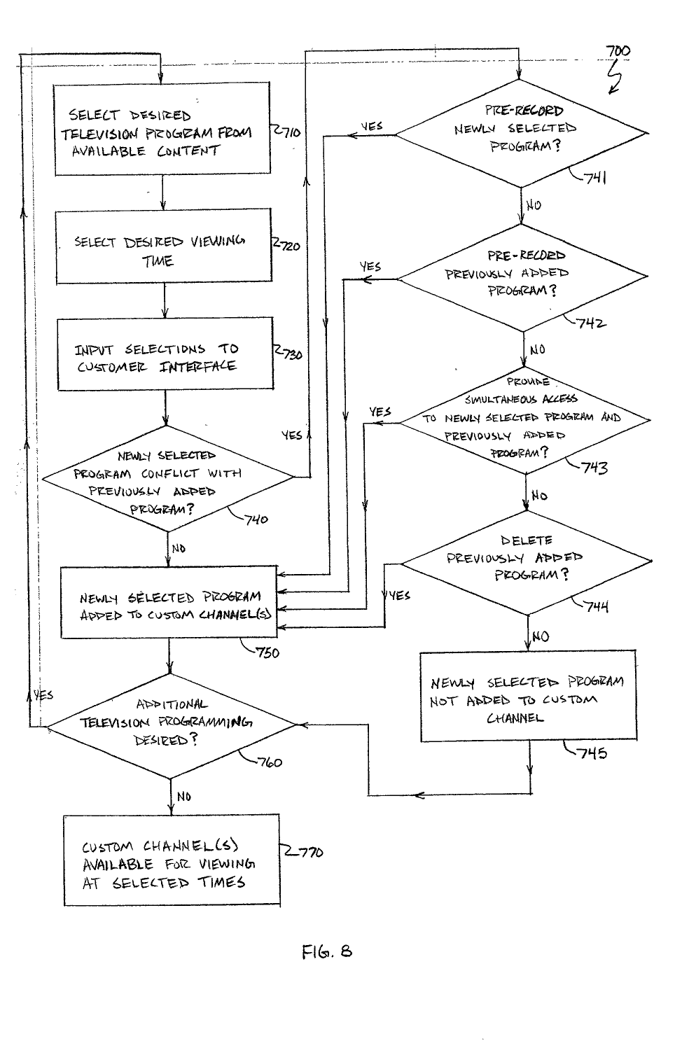

An embodiment of a method of creating a custom channel 700 is illustrated in FIG. 8. Denoted by reference numeral 710, a customer selects a desired television program from the available content, and the customer also selects a desired viewing time, which is denoted at 720. The selected viewing time may be the regular scheduled broadcast time for a television program. For example, the selected viewing time may coincide with a live broadcast (e.g., a sporting event), coincide with the scheduled broadcast time of a new episode of a popular television program, or coincide with the scheduled broadcast time for a re-run of a television program. Alternatively, the selected viewing time may be some time other than the regular scheduled broadcast time, in which case the selected television program is pre-recorded. The selected television program and viewing time are then input to the customer interface 730.

If the newly selected program does not conflict with a program previously added to the custom channel (see reference numeral 740), the newly selected program is added to the custom channel, which is denoted at 750. If, however, the newly selected program does conflict with a previously added program, it must then be determined if the newly selected program is to be pre-recorded (see reference numeral 741). If the newly selected program is to be pre-recorded, it is added to the custom channel 750 but, if not pre-recorded, it must then be determined if the previously added program is to be pre-recorded (see reference numeral 742). If the previously added program is to be pre-recorded, the newly selected program is added to the custom channel 750.

If no pre-recording is to be performed, it must then be determined if the customer desires simultaneous access to the newly selected program and the previously added program (see reference numeral 743). However, one of the newly selected program and previously added program must be added to a second, different custom channel, in which case the customer will receive both custom channels concurrently, enabling the customer to switch between the previously added and newly added programs.

If simultaneous access is not requested, it must then be determined if the previously added program is to be deleted from the custom channel (see reference numeral 744). If the previously added program is deleted, the newly selected program is added to the custom channel 750; otherwise, the newly selected program is not added to the custom channel (see reference numeral 745). Once the newly selected program is added (or not added) to the custom channel, it must be determined if additional television programming is desired, as denoted at 760. If no more programming is to be added to the custom channel, the custom channel is available for viewing at the selected times (see reference numeral 770); however, if additional programming is to be added to the custom channel, the procedure is repeated.

It should be understood that the method of building a custom channel illustrated in FIG. 8 is only exemplary. Other methods and procedures for creating custom channels may be devised by those skilled in the art, and the present invention is generally applicable to the transmission of any type of custom channel, irrespective of the particular format or method of creation.

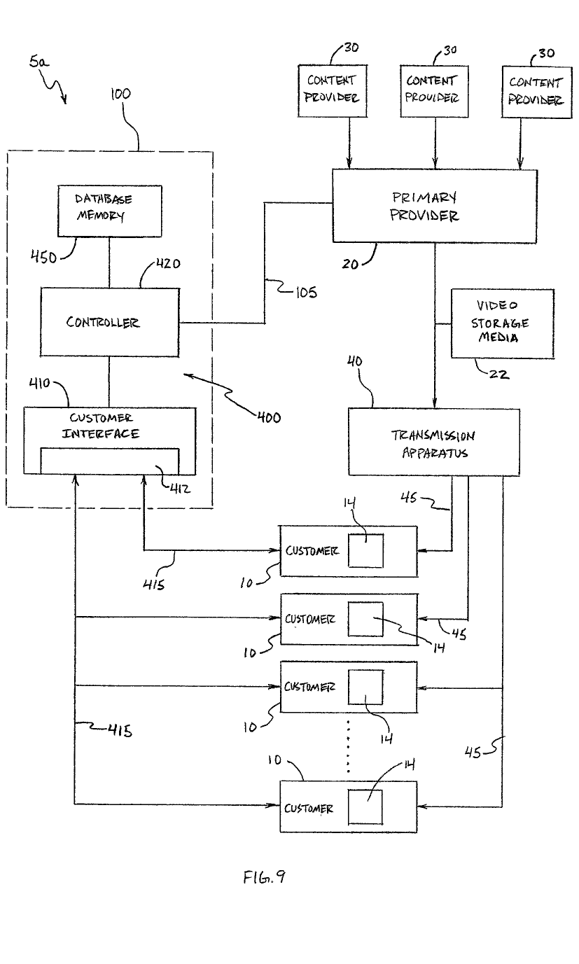

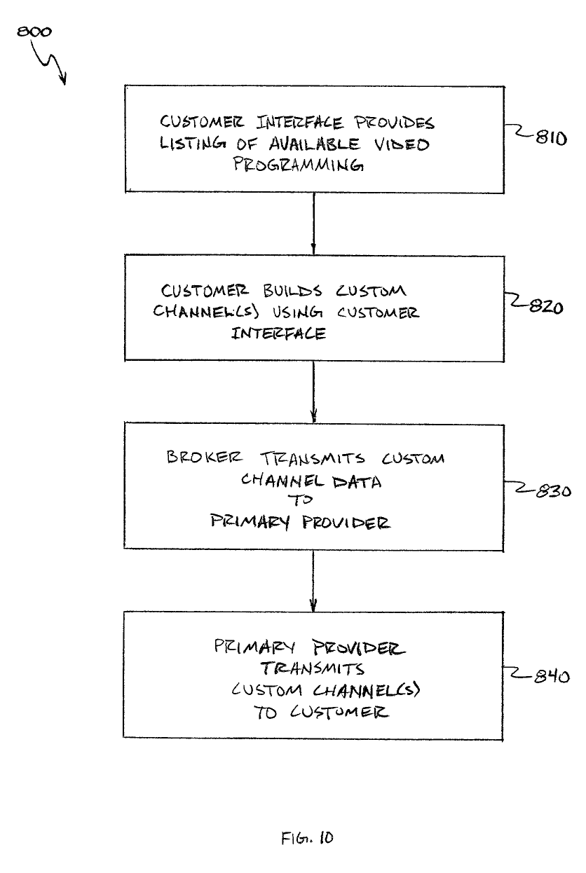

FIG. 9 and 10 illustrate yet another embodiment of the invention. Referring to FIG. 9, a brokering apparatus 400 includes a customer interface 410, which may include access circuitry 412, and a controller 420 coupled thereto. Also coupled to the controller 420 is database memory 450. The customer interface 410 is connected to one or more customers 10 via a transmission media 415, which may comprise electrical cable, fiber optics, or electromagnetic waves. A communication link 105 couples the brokering system 400 to at least one primary provider 20.

The primary provider 20 receives television programming from one or more content providers 30, as noted above, and a transmission apparatus 40 is configured to transmit television programming to the customers 10 via transmission media 45. The transmission apparatus 40 comprises a cable television distribution system, a direct-to-home satellite transmission system, a broadcasting system, or other suitable video distribution system. Coupled to the transmission apparatus 40 is video storage media 22, which may comprise magnetic tape, a hard disk drive, a server, or an optically accessible medium.

The television distribution system 5a shown in FIG. 9 is similar to that shown and described with respect to FIGS. 2 through 8; however, the brokering system 400 shown in FIG. 9 does not include a transmission apparatus. The brokering system 400 is configured to receive and store custom channel data—as well as to verify access codes, if necessary—and to transmit that custom channel data via communications link 105 to primary provider 20. It is the primary provider 20 that, in turn transmits—using transmission apparatus 40 and transmission media 45—the custom channels to customers 10. If a customer 10 desires to view a non-live (i.e., at any time other than a regular scheduled broadcast time) television program, the non-live program may be recorded and stored on video storage media 22 for subsequent viewing by the customer 10.

Referring to FIG. 10, a method of providing custom channels 800 is illustrated. Denoted at 810, customer interface 410 provides customers 10 with a listing of available television programming. A customer 10 may then build (see reference numeral 820) one or more custom channels using the customer interface 410. The broker 100 transmits via communication link 105 custom channel data for one or more customers 10 to the primary provider 20, which is denoted at 830. Referring to reference numeral 840, the primary provider 20 transmits the custom channels to each customer 10 at the selected viewing times.

Embodiments of apparatus and methods for providing custom channels to television viewers having been herein described, those of ordinary skill in the art will appreciate the advantages of the present invention. Customers can select and pay for only desired television programs, and customers are not required to subscribe to and pay for unwatched or objectionable television programming. Customers can select any desired viewing time for a television program and, as a result, may have each of two or more concurrently broadcast television programs included in one or more custom channels. Also, by assigning access levels to specific access codes, customers can limit access by younger viewers to certain types or categories of television programs. Further, a customer interface in conjunction with an electronic program guide enables customers to easily create one or more custom channels.

The foregoing detailed description and accompanying drawings are only illustrative and not restrictive. They have been provided primarily for a clear and comprehensive understanding of the present invention and no unnecessary limitations are to be understood therefrom. Numerous additions, deletions, and modifications to the embodiments described herein, as well as alternative arrangements, may be devised by those skilled in the art without departing from the spirit of the present invention and the scope of the appended claims.

What is claimed is:

1. A method for providing television programming, comprising:
providing access to television programming to enable a customer of a broker to create a custom channel including at least one television program selected from the television programming; and
transmitting the custom channel from the broker to the customer.

2. The method of claim 1, further comprising simultaneously transmitting to the customer the custom channel and at least one other custom channel, the at least one other custom channel including at least one television program selected from the television programming.

3. The method of claim 1, further comprising:
pre-recording a television program; and
transmitting to the customer a custom channel including the pre-recorded television program.

4. The method of claim 1, further comprising providing at least one access code to the customer, the access code enabling the customer to access the television programming.

5. The method of claim 4, further comprising assigning an access level to the at least one access code, the access level identifying at least one category of television programming the customer is prohibited from accessing.

6. A method for providing television programming, comprising:
providing a program guide including a listing of television programming received by a broker from at least one provider;
providing access to the program guide to enable a customer of the broker to select at least one television program from the television programming;
adding the at least one selected television program to a custom channel; and
transmitting the custom channel from the broker to the customer.

7. The method of claim 6, further comprising pre-recording the at least one selected television program.

8. The method of claim 6, further comprising prohibiting access by the customer to at least one category of television programming.

9. A method for providing television programming, comprising:
providing a program guide including a listing of television programming available from a provider;
providing access to the program guide to enable a customer of a broker to select at least one television program from the television programming;
generating custom channel data identifying the at least one selected television program; and
sending the custom channel data from the broker to the provider.

10. The method of claim 9, further comprising sending the custom channel data to one of a cable television provider and a direct-to-home satellite provider.

11. The method of claim 9, further comprising prohibiting access by the customer to at least one category of television programming.

12. A method for providing television programming, comprising:
receiving from a broker custom channel data associated with a customer, the custom channel data identifying selected television programming for at least one custom channel; and
transmitting the at least one custom channel to the customer.

13. The method of claim 12, further comprising encrypting a signal comprising the at least one custom channel.

14. The method of claim 12, further comprising pre-recording a television program and including the prerecorded television program in the at least one custom channel.

15. A method of creating a custom channel, comprising:
selecting at least one television program from a listing of available television programming;
selecting a time for viewing the at least one selected television program; and
adding the at least one selected television program and the selected time to a custom channel.

16. The method of claim 15, further comprising:
selecting from the listing of available television programming a second television program;
selecting a second time for viewing the second television program, the second time delayed relative to a scheduled broadcast time for the second television program; and
adding the second television program and the second time to the custom channel.

17. The method of claim 15, further comprising:
selecting from the listing of available television programming a second television program;
selecting a second time for viewing the second television program at least partially coinciding with the selected time for viewing the at least one selected television program; and
adding the second television program and the second time to another custom channel.

18. A system for providing television programming, comprising:
a receiver to receive television programming from at least one provider;
a customer interface providing access to the television programming to enable a customer of a broker to create a custom channel including at least one television program selected from the television programming; and
a transmitter coupled to the receiver, the transmitter to transmit the custom channel from the broker to the customer.

19. The system of claim 18, further comprising a database memory to store custom channel data identifying television programs comprising the custom channel.

20. The system of claim 18, the customer interface including one of an electronic program guide, a natural language electronic program guide, and a web-based electronic program guide.

21. The system of claim 18, further comprising a video storage medium coupled to the receiver, the video storage medium to receive and store television programming.

22. The system of claim 18, further comprising an encryption device coupled to the transmitter, the encryption device to encrypt a signal comprising the custom channel prior to transmission to the customer.

23. The system of claim 18, further comprising access circuitry coupled to the customer interface, the access circuitry to receive and verify a customer access code.

24. A system for providing television programming, comprising:
a customer interface providing access to a listing of television programming available from a provider to enable a customer of a broker to create a custom channel including at least one program selected from the television programming; and
a controller to generate custom channel data identifying the at least one selected television program and to send the custom channel data from the broker to the provider.

25. The system of claim 24, further comprising a database memory to store the custom channel data.

26. The system of claim 24, the customer interface including one of an electronic program guide, a natural language electronic program guide, and a web-based electronic program guide.

27. The system of claim 24, further comprising access circuitry coupled to the customer interface, the access circuitry to receive and verify a customer access code.

28. An article of manufacture, comprising:
a machine accessible medium, said machine accessible medium providing instructions that, when executed by a machine, cause said machine to:
provide access to television programming to enable a customer of a broker to create a custom channel including at least one television program selected from the television programming; and
transmit the custom channel from the broker to the customer.

29. The article of claim 28, said instructions, when executed, further causing said machine to simultaneously transmit to the customer the custom channel and at least one other custom channel, the at least one other custom channel including at least one television program selected from the television programming

30. The article of claim 28, said instructions, when executed, further causing said machine to:
pre-record a television program; and
transmit to the customer a custom channel including the pre-recorded television program.
